(19) United States
(12) Patent Application Publication
(10) Pub. No.: US 2007/0139751 A1
(43) Pub. Date: Jun. 21, 2007

(54) Variable mirror

(75) Inventors: Stein Kuiper, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,404

(22) PCT Filed: Mar. 24, 2005
(86) PCT No.: PCT/IB05/51010

§ 371 Date: Sep. 28, 2006

(30) Foreign Application Priority Data
Apr. 1, 2004 (EP) 04101341.8

(51) Int. Cl. G02B 26/08

(52) U.S. Cl. 359/223; 359/666

(57) ABSTRACT

A variable mirror (100; 200; 300; 400; 500; 600; 740; 922) includes a fluid chamber (130; 230), an optical axis (90) extending through at least a portion of the fluid chamber, and a first polar and/or conductive fluid (110; 210) and a second fluid (120; 220) in contact over an interface (140, 140′; 240, 240′; 340, 340′; 440, 440′; 540, 540′) extending transverse the optical axis. The fluids are substantially immiscible. The interface comprises a reflective material. An interface adjuster (250; 250′; 250″) is arranged to alter the configuration of the interface via the electro wetting effect.

The present invention relates to a variable mirror, and apparatus incorporating such a mirror, and to methods of manufacturing the same.

A mirror is a device that is arranged to reflect light. The term light is understood to include both visible electromagnetic radiation, and other wavelengths of electromagnetic radiation.

A variable mirror is a mirror in which the configuration of the reflective portion of the mirror can be varied i.e. at least one of the position, orientation and shape of the reflective portion of the mirror can be varied.

Variable mirrors can be utilised in a variety of applications, including within optical scanning devices. Optical scanning devices are devices that scan an optical record carrier, for reading and/or writing information from/to the carrier. Examples of optical record carriers include CDs (Compact Discs) and DVDs (Digital Versatile Discs).

U.S. Pat. No. 6,002,661 describes the use of deformable mirrors (mirrors in which the reflective surface can be controllably deformed) in data reproducing apparatus for DVDs and CDs. Due to the difference in thickness of the cover layer between CDs and DVDs, it can be difficult for data reproducing apparatus to obtain high quality data reproduction signals. Electrically controllable deformable mirrors are utilised to correct defocusing operations in the optical scanning system.

U.S. Pat. No. 6,002,661 describes how the mirrors can be deformed by using piezoelectric actuators to press against and deform the mirrored surface. U.S. Pat. No. 6,002,661 also describes a deformable mirror that utilises a flexible reflective surface that can be fitted to either a first reference surface or a second, differently shaped reference surface. U.S. Pat. No. 5,880,896 describes a deformable mirror for use in an optical disc recording/reproducing apparatus. The reflective surface of the mirror is adjusted by controllably deforming a flexible member having a reflective surface, the member being deformed by an electrostatic stress.

Such deformable mirrors are susceptible to wear, as the mirror is continually stressed and de-stressed to obtain the desired shape. Further, deforming the reflective surface in the desired manner is difficult to control, and consequently it is relatively expensive to provide a deformable optical mirror of good optical quality.

It is an aim of embodiments of the present invention to provide a variable mirror that addresses one or more of the problems of the prior art, whether referred to herein or otherwise. It is also an aim of embodiments of the present invention to provide optical devices incorporating such improved variable mirrors, and methods of manufacturing such improved variable mirrors and such optical devices.

It is an aim of particular embodiments of the present invention to provide a variable mirror in which the optical path is relatively unsusceptible to mechanical wear and tear during operation.

According to a first aspect of the present invention there is provided a variable mirror comprising: a fluid chamber; an optical axis extending through at least a portion of the fluid chamber; a first polar and/or conductive fluid and a second fluid in contact over an interface extending transverse the optical axis, the fluids being substantially immiscible; an interface adjuster arranged to alter the configuration of the interface via the electrowetting effect; and wherein the interface comprises a reflective material.

By providing such a variable mirror, the configuration of the mirror may easily be varied by adjusting the configuration of the interface. The device can be manufactured relatively cheaply. The interface may be arranged to have a variety of configurations, depending upon the control signals applied to the mirror. Further, as the reflective portion of the mirror is not provided by a solid layer, the mirror is relatively unsusceptible to fatigue.

The reflective material may comprise a metal.

The reflective material may comprise a Metal Liquid-Like Film.

The reflective material may comprise a thin metal layer on an organic polymer film.

The interface adjuster may comprise: a first electrowetting electrode in electrical contact with the first fluid; at least one second electrowetting electrode located adjacent the interface; and a voltage source for applying a voltage between said first and second electrodes for altering the configuration of said interface.

An edge of said interface may be constrained by the fluid chamber, and the second electrowetting electrode may be arranged to act on at least a portion of the interface edge. The second electrode may be separated from the interface by at least a portion of said second fluid.

According to a second aspect of the invention there is provided an optical device comprising a variable mirror as described above.

The optical device may comprise a laser cavity including said variable mirror, the cavity further including a second mirror.

The optical device may comprise a Maksutov Cassegrain catadioptric system comprising a primary mirror and a secondary mirror, the primary mirror being formed by said variable mirror.

The optical device may comprise an optical scanning device for scanning an optical record carrier.

According to a third aspect of the present invention there is provided a method of manufacturing a variable mirror, the method comprising the steps of: providing a fluid chamber, with an optical axis extending through at least a portion of the fluid chamber; providing a first polar and/or conductive fluid and a second fluid in contact over an interface extending transverse of the optical axis, the fluids being substantially immiscible, and the interface comprising a reflective material; and providing an interface adjuster arranged to alter the configuration of the interface via the electrowetting effect.

According to a fourth aspect of the present invention there is provided a method of operating an optical device, the optical device comprising a variable mirror as described above, the method comprising controllably altering the configuration of the interface so that the mirror provides the desired reflective properties.

Embodiments of the invention will now be described, by way of example only, with reference to the accompanying drawings, in which:

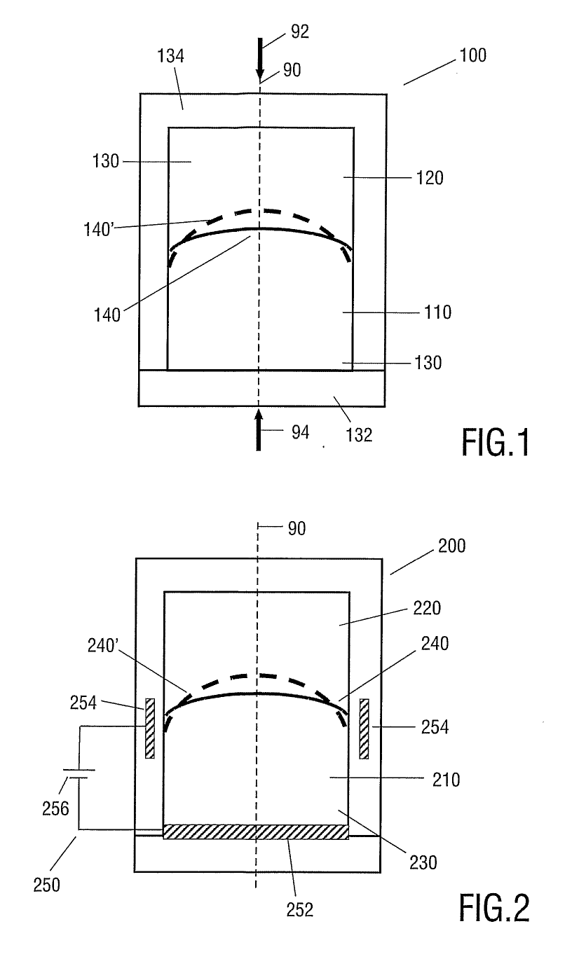

FIG. 1 is a generalised cross-sectional view of a variable mirror in accordance with an embodiment of the present invention;

FIG. 2 is a cross-sectional view of an embodiment of a variable mirror controlled by electrowetting;

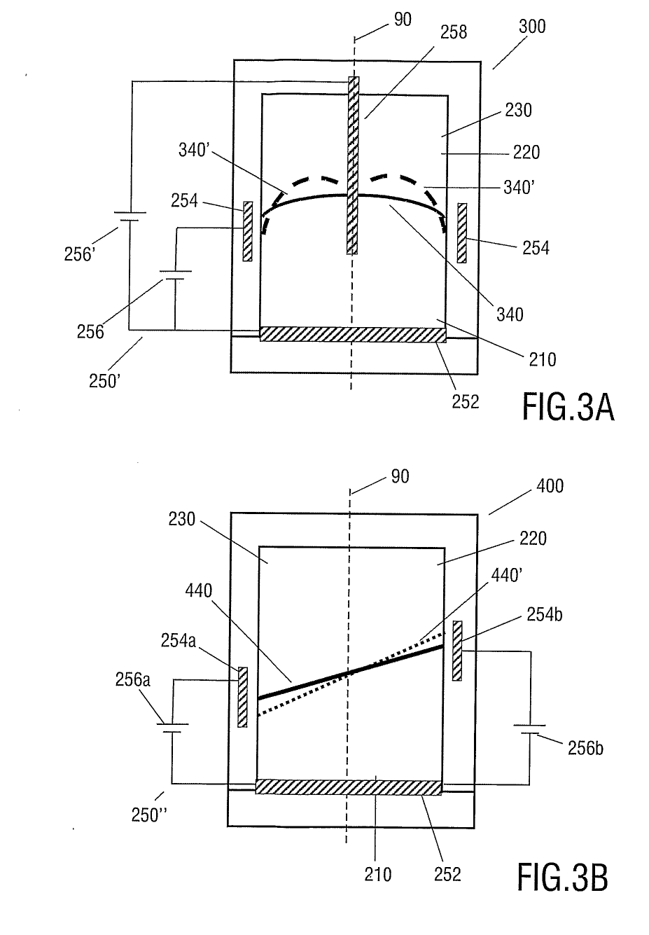

FIGS. 3A and 3B are cross-sectional views of alternative embodiments of variable mirrors controlled by electrowetting;

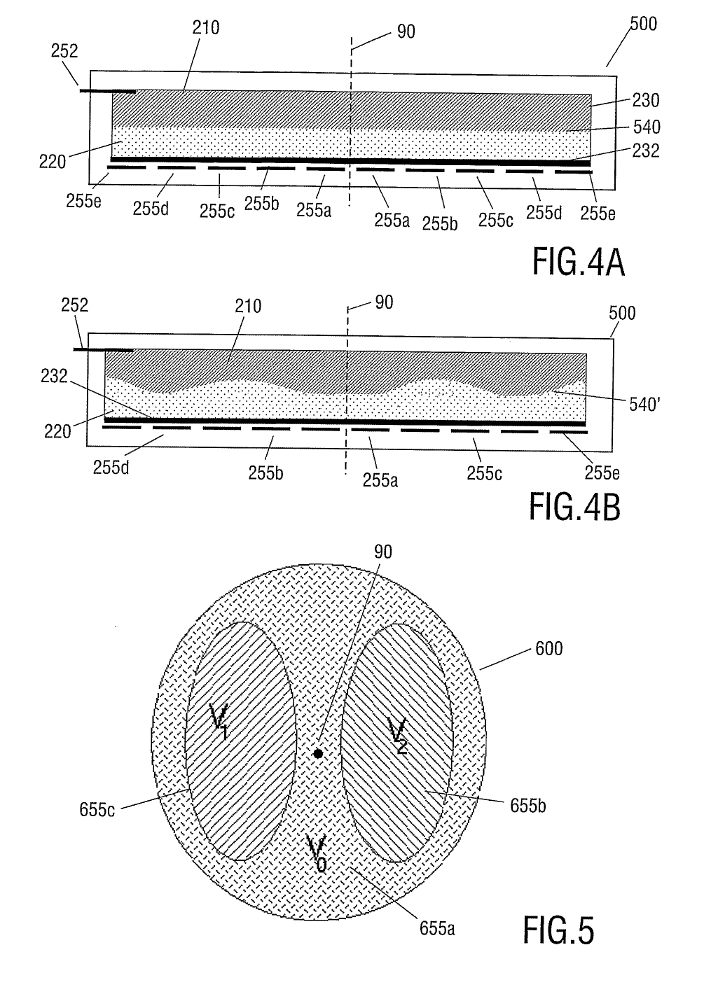

FIGS. 4A and 4B are respective cross-sectional views of a further embodiment of a variable mirror in two different configurations;

FIG. 5 is a plan view of an electrode layout of a variable mirror suitable for generating coma wavefront aberration;

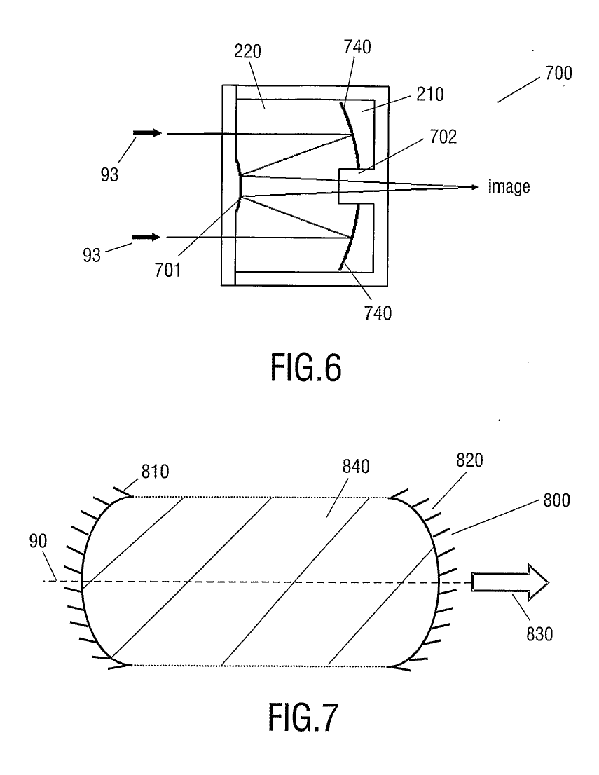

FIG. 6 is an embodiment of a variable mirror being utilised as the switchable primary mirror in a Maksutov Cassegrain catadioptric system;

FIG. 7 is a schematic diagram of a laser cavity incorporating at least one embodiment of the present invention; and

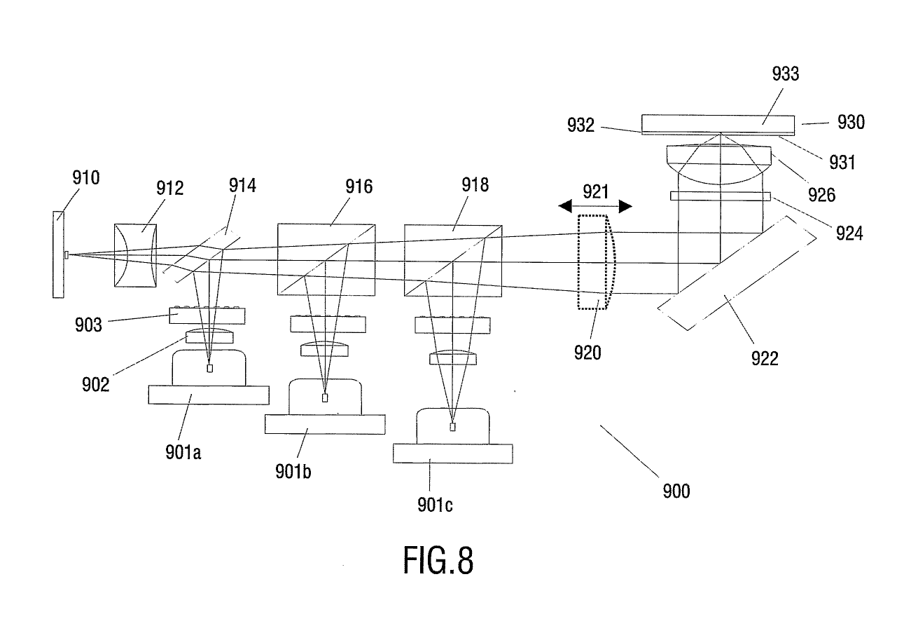

FIG. 8 is a schematic diagram of an optical scanning device incorporating a variable mirror in accordance with an embodiment of the present invention.

FIG. 1 shows a variable mirror 100 in accordance with a first, generalised embodiment of the present invention. The mirror 100 is formed of two fluids 110,120 contained within a fluid chamber 130. A fluid is a substance that alters its shape in response to any force that tends to flow or to conform to the outline of its chamber, that includes gases, vapours, liquids and mixtures of solids and liquids capable of flow.

The two fluids 110, 120 are substantially immiscible i.e. the two fluids do not mix.

An interface 140 is formed by the meniscus extending along the contact area between the two fluids 110, 120. The interface 140 comprises a reflective material, such that the interface provides the reflective portion of the mirror.

The interface 140 extends transverse the optical axis of the mirror 100. The term transverse indicates that the interface crosses (i.e. it extends across) the optical axis, and that it is not parallel to the optical axis; the interface may cross the optical axis 90 at any angle.

The reflective portion may be arranged to be only partially reflective (e.g. to have a reflectivity of 10% or 50%), or to be highly reflective (e.g. to have a reflectivity of greater than 90%, or even greater than 98%).

The reflective material at the interface may take a number of forms. For instance, the article “Optical Tests of Nanoengineered Liquid Mirrors” by Hèlène Yockell-Leliévre et al. (Applied Optics vol. 42 (2003) p 1882) describes how high-quality mirrors can be fabricated by chemically producing a large number of metallic nano-particles coated with organic lingands. The particles are then spread on a liquid substrate, where they self-assemble to give optical quality reflective surfaces.

Equally, the article “Ferrofluid Based Deformable Mirrors—A New Approach to Adaptive Optics using Liquid Mirrors” by P. Laird et al (Proceedings SPIE vol. 4839 (2003) p 733) describes how a highly reflective liquid surface can be obtained by the application of a thin film composed of silver nano-particles. Stable interfacial suspensions of silver particles are known in the literature, and are commonly referred to Metal Liquid-Like Films (MELLFs). Such systems combine the optical properties of metals with the fluidity of a liquid suspension. The MELLF forms an extremely thin layer that follows the substrate very closely, allowing precise control of the reflective surface. The fabrication of a MELLF involves creation of silver nano-particles, generally by chemical reduction of a silver salt in axious solution, and the subsequent coating of the particles with an organic ligand. When coated, the particles are no longer stable in the aqueous phase, and spontaneously assembly at the water-organic interface. The roll of a surfactant is significant to both the surface assembly of the particles and, their stabilisation during aggregation. Further, similar interfacial films using gold have been demonstrated, and it is believed other metals may also be used to tailor the reflectivity and spectral response of the resulting reflective surface to the desired application.

Further, the article by E. F. Borra, A. M. Ritcey and E. Artigau, “Floating mirrors,” Astrophys. J. Letters, 516, L115-118 (1999) described two different techniques for depositing a high-reflectivity layer on a liquid. The first technique relates to the selective deposition of a thin metal layer on an organic polymer film spread at a liquid-interface. The process relies on the reduction of metal ions in solution by organic molecules that are located only at the surface. The second technique relates to different ways of producing MELLFs.

The fluids 110, 120 are enclosed within the chamber 130 defined by walls 132, 134. At least a portion of one of the walls 132, 134 lying along the optical axis 90 is transparent. In this particular embodiment, both portions of the walls 132, 134 lying along the optical axis 90 are transparent, such that the light 92 incident upon the interface 140 would reflect from the interface 140 as though from a convex mirror, and light 94 incident upon the interface 140 will reflect from the interface 140 as though from a concave mirror.

Typically, in order to locate the fluids within the desired portion of the chamber 130, different areas of the chamber will have different wettabilities for each fluid, such that each fluid will be attracted to a respective area. Wettability is the extent by which a side is wetted (covered) by a fluid. For instance, if the fluid 110 is a polar fluid and the fluid 120 is a non-polar fluid, then a portion of the area of the inside surface of the chamber overlying the wall 132 may be hydrophilic so as to attract the polar fluid 110, and not attract the non-polar fluid 120.

By adjusting the configuration of the interface 140, then the mirror function provided by the variable mirror 100 can be changed. For instance, if the interface 140 is made more curved (i.e. it takes the shape shown by dotted line 140′), then the resulting mirror function will be that of a mirror having a smaller radius of curvature.

An interface adjuster is used to alter the configuration of the interface 140, by utilising the electrowetting effect. Typically the fluid must be a conductive fluid to experience the electrowetting effect. In electrowetting, the extent by which a fluid wets (i.e. covers) a surface is changed with applied voltage. For instance, WO 03/069380 describes the use of an electrowetting effect to alter the shape of a meniscus between two non-miscible fluids.

FIG. 2 shows a variable mirror 200 in which the three-phase contact angle is changed with applied voltage. The three-phases constitute two fluids and a solid. Typically, at least the first fluid is a liquid. The device 200 comprises a first fluid 210 and a second fluid 220, the two fluids being immiscible. The second fluid 220 is a non-conducting non-polar liquid, such as a silicone oil or an alkane. The first fluid 210 is a conductive and/or polar liquid such as water containing a salt solution (or a mixture of water and ethylene glycol).

The two fluids 210, 220 are preferably arranged to have an equal density, so as to minimise the gravitational effects between the two liquids such that the mirror functions independently of orientation. The interface 240 between the two fluids 210, 220 comprises a reflective material.

Varying the shape of the interface 240 will vary the effective shape of the mirror. The shape of the interface 240 is adjusted by the electrowetting phenomenon, by use of the interface adjuster 250. The interface adjuster comprises an electrode 252 in electrical contact with the polar fluid 210, and a second, annular electrode extending beneath the interior surface of the chamber 230, at a position corresponding to the point at which the interface 240 contacts the surface of the chamber 230. The electrode 254 is not in conductive contact with the polar fluid 210. The annular electrode 254 extends around the mirror 200 in proximity to the three-phase line.

A voltage is applied from the variable voltage source 256 across the polar liquid 210 via the electrodes 252, 256. The electrowetting effect is thus used to increase the wettability of a polar or conducting fluid on the surface, which leads to a change in the three-phase contact angle of the two fluids 210, 220, and thus to a change in the shape of the interface 240 (e.g. to the shape shown by dotted line 240′).

If the wettability of a surface is initially small (for a polar liquid this is usually termed a hydrophobic surface, e.g. a Teflon-like surface), a voltage can be used to make it larger. If the wettability is initially large (for a polar liquid this is usually called a hydrophilic surface, e.g. silicon dioxide) then applying a voltage will have relatively little effect. It is therefore preferable that in such electrowetting devices, the three-phase line is initially in contact with a hydrophobic layer.

In this particular embodiment, it is envisaged that the device is generally formed as a cylinder, with the optical axis 90 extending longitudinally through the cylinder. However, it will be appreciated that the device can in fact take a number of other configurations.

FIG. 3A shows a variable mirror 300 in accordance with a further embodiment of the present invention. The embodiment shown in FIG. 3A is generally similar to that shown in FIG. 2, with identical reference numerals being utilised to represent similar features. In this particular embodiment, the interface adjuster 250′ additionally includes a third electrode 258, and a corresponding voltage source 256′ for applying a voltage between the third electrode 258 and the electrode 252 in contact with the polar fluid. The electrode 258 extends through the interface 340 between the two fluids 210, 230. The electrode 258 is not in electrical contact with the polar fluid 210, but has an insulative covering. By applying a voltage to the electrode 258, the wettability of the insulative covering of the electrode can be adjusted, thus altering the shape of the interface 340 (e.g. to 340′) through which the electrode 258 extends.

In this particular embodiment, the electrode 258 is transparent, and preferably also relatively thin, such that it will not interfere with light directed at the interface 340, 340′ for reflection.

In this particular embodiment, the third electrode 258 extends through the interface 340 along the optical axis, and the electrode is circularly symmetric (e.g. a cylinder). Such an electrode can be used to introduce a number of novel shapes to the reflective interface 340, 340′, which are circularly symmetric. Such shapes will be realised by appropriate adjustment of the control which is provided by voltage sources 256, 256′.

In the above embodiments, the meniscus (the interface between the two fluids) has been indicated as being curved, and generally symmetrical with respect to the optical axis. However, it will be appreciated that, depending upon the desired optical function to be performed by the reflective interface, any or all of these conditions can be changed.

For instance, the interface can be substantially flat (i.e. planar). The shape of the meniscus can be non-symmetrical with respect to the optical axis, and it can be inclined at an angle to the optical axis. For instance, such effects can be achieved by using surfaces and/or electrode configurations that provide different electrowetting properties at different points around the circumference of the interface. Such different electrowetting properties will result in different parts of the circumference experiencing different contact angles with the relevant surfaces, hence changing the overall shape of the interface. Equally, it will be appreciated that different meniscus configurations can be achieved by utilising electrowetting and having one or more of the surfaces with which the meniscus contacts being non-parallel to the optical axis.

FIG. 3B illustrates a simplified cross-sectional view of a variable mirror 400 in accordance with another embodiment of the present invention. In this particular embodiment, in the cross-section shown, the two side walls have different wettabilities with respect to the two fluids at a contact. This difference in wettability can be due either to the intrinsic nature of the side walls (e.g. with the surfaces being formed of different materials) or by applying the electrowetting effects so as to change the wettability of one surface a greater amount than the other surface. If desired, each portion of the side wall contacting the circumference of the interface can be arranged to have a different wettability.

By adjusting the wettability of the relevant surface areas appropriately, the contact angles at which the meniscus 440 contacts the surface can be altered, thus changing the shape of the interface. For instance, the meniscus 440 is shown as being essentially planar (at least with respect to the particular cross-section taken), and at a particular angle with respect to the optical axis 90.

Each portion of the surface which the meniscus contacts has a respective electrode 254a, 254b, and a respective variable voltage source 256a, 256b. By applying a voltage between electrodes 254a, 254b and the electrode 252 in contact with the polar fluid 210, the interface adjuster 250″ can adjust the wettabilities at each point at which the interface 440 contacts the interior surface of the chamber 230.

For instance, if desired, by appropriately altering the wettability of the surfaces using the electrowetting effect, then the angle of the planar meniscus 440 can be adjusted to a different angle with respect to the optical axis e.g. to form meniscus 440′. Alternately, by appropriate selection of contact angles, the shape of the meniscus can be adjusted, so as to form a curved meniscus. The net result would be that the meniscus shape or position is altered, so as to provide a different optical function i.e. a differently shaped optically reflective surface.

In most electrowetting devices, the shape of the interface between the fluids is determined by influencing the contact angle(s) of the meniscus with the wall(s). Generally, in between the walls the interface is not influenced, and takes the shape that belongs to a state of a minimum in surface free energy. However, the present inventors have realised that it is possible to pull a conducting fluid towards electrodes that are placed beneath a layer of insulating fluid. By appropriate control of the voltage, this electrowetting phenomenon can be used to ensure that the conducting fluid does not touch the electrodes, and a curve interface will arise.

FIGS. s 4A and 4B show a variable mirror 500 in accordance with an embodiment of the present invention that utilities this principle. The mirror 500 comprises a cylindrical chamber 230 containing a conducting liquid 210 and an insulating liquid 220. The two liquids 210, 220 are in contact along interface 540, which comprises reflective material. An electrode 252 is in electrical contact with the conducting liquid 210.

Optical axis 90 extends along the longitudinal axis of the cylindrical chamber 230. A hydrophobic layer 232 is located on an inside surface of one side of the chamber 230, to locate the insulating liquid. Electrodes (255a-255e) are disposed beneath the surface of the insulating hydrophobic layer. Each of the electrodes 255a, 255b, 255c, 255d, 255e is annular, and extends around the optical axis 90. By appropriate control voltages between the electrode 252 and any one or more of the electrodes 255a-255e, a spherical wavefront aberration can be generated. This can be used for compensation of a spherical wavefront aberration arising when switching from one readout layer to another readout layer in dual layer optical readout systems.

Preferably, the insulating layer covering the hydrophobic surface is relatively thin e.g. a thin oil layer of thickness 200 μm or less, and more probably a thickness of approximately 100 μm.

FIG. 4A illustrates the variable mirror 500 in which no voltages are being applied between the electrodes 252 and any one of the electrodes 255a-255e. In this particular embodiment, the wettability of the walls at which the interface contacts is arranged such that the interface will have a contact angle of approximately 90°, such that the interface remains generally planar. For example, the part of the wall lying on one side of the interface (e.g. the upper part) may be hydrophilic and the other part of the wall (e.g. the lower part) hydrophobic.

FIG. 4B illustrates the instance in which a first voltage is applied between annular electrode 255d and electrode 252, and a second voltage is applied between annular electrode 255a and electrode 252. It will be seen that these voltages are applied so as to pull the portion of the conductive liquid overlying the electrodes towards the electrodes, thus leading to deformation of the interface configuration 540′.

It will be appreciated that in the above embodiments, the fluid chambers can be any desired shape e.g. conical, cylindrical etc. Further, the electrodes may be in any desired shape e.g. annular, segmented or have any arbitrary shape, to provide the desired shape electrical surface. For instance, FIG. 5 shows a plan view of a variable mirror 600 that is generally similar to the variable mirror 500, apart from the arrangement of the electrodes underlying the hydrophobic layer 232. In this particular embodiment, the variable mirror 600 has a series of electrodes that are not circularly symmetric with respect to the optical axis 90. Instead, two of the electrodes 655b, 655c are generally elliptical in shape, and disposed in a common plane either side of the optical axis 90. A third electrode 655a extends across the remainder of the base area of the chamber not covered by the electrical electrodes 655b, 655c. By applying a voltage between each of the electrodes 655a-c and the electrode 252, a coma aberration generating reflective surface is generated. Such a coma wavefront generating surface could be used in an optical recording pick up to correct coma aberration arising from disk tilt. A suitable technique to achieve the desired surface is to apply zero volts between 655a and electrode 252, and +V₁ volts between 655b and 252, and −V₁ volts between 655c and 252.

In the above embodiments, the variable mirror has been shown as comprising a single variable optical device formed by the reflective interface between two fluids, the interface being of variable configuration. However, it will be appreciated that alternative embodiments can comprise a plurality of variable optical devices or a plurality of reflective surfaces. For instance, a lens (e.g. a variable lens) could be concatenated with the variable mirror. Alternatively, a large variable mirror could be formed of an array of individual variable mirrors in accordance with one or more of the embodiments of the invention.

Further, a variable mirror can be incorporated as one or more of the mirrors in a two-mirror imaging system. Two mirror imaging systems exist in many forms, such as the Newton telescope, Cassegrain, Maksutov Cassegrain, and Schwarzschild types. The last type can also be utilised in optical recording to realise a compact height objective system, or in near field optical recording. Embodiments of the variable mirror of the invention is particularly suited for these applications, because it allows for a compact objective with aberration correction included due to the variable mirror configuration.

In FIG. 6, an example of a Maksutov Cassegrain catadioptric system 700 is shown. In this particular embodiment, the system 700 utilises the interface 740 containing reflective material as the switchable primary mirror. A second, fixed mirror 701 acts as the secondary mirror. The central opening 702 in the primary mirror can easily be obtained by forming an extrusion in the chamber containing the two fluids 210, 220. Incident light 93 first reflects of the reflective interface 740 acting as the primary mirror, on to the secondary mirror 701 and then through an opening 702 in the primary mirror to form an image.

It will also be appreciated that embodiments of the present invention can generally be utilised in optical scanning, microscopy, telescopes, laser cavities and in optics for cameras.

For example, within lasers, a two-mirror resonator (also termed a resonant cavity) is commonly used. The mirrors can be planar, concave or convex. By fixing the curvature of the two mirrors and the length of the cavity, a well defined Gaussian resonator mode can be selected having the desired properties. By placing passive elements in the resonator the laser mode can be affected, as for instance described within C. Pare et al, IEEE J. Quantum Electron. 28 (1994) pg 355, J Leger et al, Opt. Lett. 19 (1994) pg 108. The present invention can be used to increase the design space of such resonators by actively altering the mode of the resonator. To alter the mode of the resonator, the curvature of at least one of the mirrors is adjusted. This can be achieved by using a variable mirror in accordance with an embodiment of the present invention.

FIG. 7 illustrates a laser cavity 800 comprising first and second mirrors 810, 820. At least one of the mirrors 810, 820 is an adjustable mirror. In order to allow the output 830 of laser light, the mirror 820 is partially transmissive. A gain medium 840 typically lies between the two mirrors 810, 820. Curvature of one or more of the mirrors is adjusted to provide the desired optical mode. The effect of the curvature upon the mode has been described extensively in “Laser Beams and Resonators”, H. Kogelnik and T. Li, Appl. Opt. 5 (1966) pp 1550-1567, and also in the book “Lasers”, A. E. Siegman, University Science Books, Mill Valley, Calif., Chapter 19. In Chapter 19.2, eight different resonator types are described: (1) Symmetric resonators, (2) half-symmetric resonators, (3) symmetric confocal resonators, (4) long-radius (near-planar) resonators, (5) near-concentric resonators, (6) hemispherical resonators (7) concave-convex resonators and (8) unstable confocal resonators. Each of these types has their own properties. By altering the curvature or position of the meniscus between the two fluids in a variable mirror, the cavity 800 can be switched between the desired resonance modes.

FIG. 8 shows an optical scanning device 900 incorporating a variable mirror 922 in accordance with an embodiment of the present invention. The optical scanning device 900 is used to scan an optical disc 930. This particular optical scanning device is compatible with a variety of optical record carrier formats e.g. CD format, DVD format and BD (Blu-ray Disc format).

Typically, each optical record carrier 930 will comprise a transparent layer 932, one side of which is provided with an information layer 931. The side of the information layer facing away from the transparent layer is protected from ambient influences by a protection layer 933. The side of the transparent layer facing the device 900 is referred to as the entrance face. Information may be stored in the information layer 931 of the record carrier in the form of optically detectable marks arranged in substantially parallel, concentric or spiral tracks, not indicated in the fig. These marks may have any optically readable form.

The scanning device 900 in this embodiment comprises a separate radiation source 901a, 901b, 901c for each type of optical record carrier. Each radiation source is suitable for providing the correct wavelength of electromagnetic radiation for scanning the relevant optical record carrier. However, it will be appreciated in other embodiments, a single tuneable optical source could replace the three illustrated sources.

Light from each optical source 901a, 901b, 901c passes through a respective pre-collimator lens 902, and through a grating 903, and into the optical beam path via a respective beam splitter, which reflects light towards the optical record carrier 930.

The light then passes through collimator lens 920, is reflected off folding mirror 922, through the quarter-wave plate 924 and into the objective lens 926. Light incident on the objective lens 926 should be in the form of a collimated beam, such that the objective lens 926 transforms the collimated radiation beam into a converging beam incident on the information layer 931 of the optical record carrier. Light from the information layer of the optical record carrier then passes back through the system, included being transmitted through each of the relevant beam splitters 914, 916, 918 (without reflection), through the servo lens 912, to be detected by detector 910.

Typically, in order to correct for the different wavelengths of electromagnetic radiation used to scan each respective record carrier, the collimator lens 920 is moved (as indicated by double headed arrow 921).

However, in this particular embodiment, the collimator lens 920 is fixed. Accurate collimation of the radiation beam incident upon the objective lens 926 from the quarter-wave plate 924 is instead achieved by utilising a variable mirror in the position of the folding mirror 922. Consequently, a device used to alter the position of the collimator lens 920 (which may have been susceptible to mechanical fatigue), can be replaced by a fixed collimator lens and a variable configuration mirror.

It will be appreciated that by providing a variable mirror comprising an interface between two fluids, the interface comprising reflective material, the present invention provides a variable mirror in which the optical path does not suffer from mechanical fatigue. Further, the device can be made cost effectively and it can be easily controlled.

Any reference signs utilised in the claims are provided by way of example only, and are not to be construed as limiting the claims in any way.

1. A variable mirror (100;200;300;400;500;600;740;922) comprising:
a fluid chamber (130;230);
an optical axis (90) extending through at least a portion of the fluid chamber;
a first polar and/or conductive fluid (110;210) and a second fluid (120;220) in contact over an interface (140,140′;240,240′;340,340′;440,440′;540,540′) extending transverse the optical axis, the fluids being substantially immiscible;
an interface adjuster (250;250′;250″) arranged to alter the configuration of the interface via the electrowetting effect; and wherein the interface comprises a reflective material.

2. A mirror as claimed in claim 1, wherein the reflective material comprises a metal.

3. A mirror as claimed in claim 1, wherein the reflective material comprises a Metal Liquid-Like Film.

4. A mirror as claimed in claim 1, wherein the reflective material comprises a thin metal layer on an organic polymer film.

5. A mirror as claimed in claim 1, wherein the interface adjuster (250;250′;250″) comprises:
a first electrowetting electrode (252) in electrical contact with the first fluid (110;210);
at least one second electrowetting electrode (254,254a,254b; 255a,255b,255c, 255d, 255e) located adjacent the interface (140,140′;240,240′;340,340′;440,440′;540,540′); and
a voltage source (256;256′;256a;256b) for applying a voltage between said first and second electrodes for altering the configuration of said interface.

6. A mirror as claimed in claim 5, wherein an edge of said interface (140,140′;240,240′;340,340′;440,440′) is constrained by the fluid chamber (130;230), and the second electrowetting electrode (254,254a,254b) is arranged to act on at least a portion of the interface edge.

7. A mirror as claimed in claim 5, wherein the second electrode (255a, 255b, 255c, 255d, 255e) is separated from the interface (540,540′) by at least a portion of said second fluid (220).

8. An optical device (700;800;900) comprising a variable mirror as claimed in claim 1.

9. An optical device as claimed in claim 8, wherein the optical device comprises a laser cavity (800) including said variable mirror, the cavity further including a second mirror.

10. An optical device as claimed in claim 8, wherein said optical device comprises a Maksutov Cassegrain catadioptric system (700) comprising a primary mirror (740) and a secondary mirror (701), the primary mirror being formed by said variable mirror.

11. An optical device as claimed in claim 8, wherein the optical device comprises an optical scanning device (900) for scanning an optical record carrier.

12. A method of manufacturing a variable mirror (100;200;300; 400;500;600;740;922), the method comprising the steps of:
providing a fluid chamber (130;230), with an optical axis (90) extending through at least a portion of the fluid chamber;
providing a first polar and/or conductive fluid (110;210) and a second fluid (120;220) in contact over an interface (140,140′;240,240′;340,340′; 440,440′;540,540′) extending transverse of the optical axis, the fluids being substantially immiscible, and the interface comprising a reflective material; and
providing an interface adjuster (250;250′;250″) arranged to alter the configuration of the interface via the electrowetting effect.

13. A method of operating an optical device (700;800;900), the optical device comprising a variable mirror as claimed in claim 1, the method comprising controllably altering the configuration of the interface (140,140′;240, 240′;340,340′;440,440′; 540,540′) so that the mirror provides the desired reflective properties.
